(19) United States
(12) Patent Application Publication
(10) Pub. No.: US 2008/0248816 A1
(43) Pub. Date: Oct. 9, 2008

(54) Information Terminal

(75) Inventors: Kouji Hatano, Tokyo (JP); Yasuki Yamakawa, Kanagawa (JP); Tetsuya Ushijima, Kanagawa (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Kadoma-shi, Osaka (JP)

(21) Appl. No.: 11/568,319

(22) PCT Filed: Jun. 28, 2005
(86) PCT No.: PCT/JP2005/011841

§ 371 Date: Oct. 26, 2006

(30) Foreign Application Priority Data
Aug. 27, 2004 (JP) 2004-247928

(51) Int. Cl. H04Q 7/20

(52) U.S. Cl. 455/458; 381/107

(57) ABSTRACT

It is an object of the present invention to suppress an increase of a processing load caused due to a cross fade process and implement the cross fade process simply. An information terminal of the present invention includes a contents reproducing portion 40 for reproducing contents data, a ringtone reproducing portion 50 for reproducing a ringtone by detecting an incoming call from an external equipment, a mixer portion 60 for executing a cross fade process to fade out a reproduced output of the contents data and fade in a reproduced output of the ringtone and outputting a superposed output of the contents data and the ringtone, and a controlling portion 30 for detecting the incoming call from the external equipment and instructing to execute the cross fade process.

### TECHNICAL FIELD

The present invention relates to an information terminal having a function of reproducing various contents such as music, moving picture, television broadcast, and the like and, more particularly, an information terminal capable of controlling a contents reproducing operation when a phone call incomes into the terminal during reproduction of the contents.

### BACKGROUND ART

In recent years, in accordance with a size reduction and a capacity increase of a memory and improvements in sound compressing technology, various contents such as music, moving picture, television broadcast, and the like can be reproduced readily by a mobile terminal such as a cellular phone, or the like. In the wake of this development, a switching between an output level of a ringtone of a phone call, a speaking voice, etc. and an output level of the reproduced contents and a balance control between them constitute important control factors. Thus, the cellular phone that adjusts these factors adequately during the phone call or the speaking by phone, and the like have been proposed (see Patent Literature 1, for example).

Patent Literature 1: JP-A-2002-199056 (pages 6 to 15, FIG. 2)

### DISCLOSURE OF THE INVENTION

### Problems that the Invention is to Solve

The cellular phone disclosed in Patent Literature 1 includes a reproducing portion for reproducing music data recorded in a music data recording medium and a ringtone, a communicating portion for detecting an incoming call sent out from the external device, and a controlling portion for controlling outputs of the music data and the ringtone. When the communicating portion detects the incoming call while the reproducing portion is reproducing the music data, the controlling portion instructs the reproducing portion to output the music data and the ringtone while applying a fade-out process to the music data being now reproduced and applying a fade-in process to the ringtone. Such a situation can be avoided by this cellular phone that, for example, the output is switched into reproduction of the loud ringtone, which causes the user wake up hastily, during reproduction of the quiet music. Therefore, the user of the cellular phone can recognize the sudden phone call without a sense of discomfort.

However, in the cellular phone in the prior art, since the controlling portion instructs directly one by one respective sound sources to execute a cross fade control that increases gradually a volume of the ringtone and decreases gradually a volume of the music data, a processing load of the controlling portion (CPU) is increased. Also, since the process must be executed every sound source, a control program must be varied or modified when the sound source or a type of the sound source is changed. Thus, a versatility of a program is lost and a control becomes complicated. If it is taken into account that types of reproducible contents are increased with an increase in high functions of the cellular phone terminal such as a digital camera, a television telephone, or the like and thus an increase of the processing load of the CPU is forecasted more and more in future, it is preferable that the processing load of the cross fade process should also be reduced as small as possible.

It is an object of the present invention to provide an information terminal capable of suppressing an increase of a processing load caused due to a cross fade process and implementing the cross fade process simply.

### Means for Solving the Problems

An information terminal of the present invention having a contents reproducing function, which includes a contents reproducing unit that reproduces contents data, an informing sound reproducing unit that reproduces an informing sound of occurrence of an event by detecting the event from an external equipment, a superposing unit that executes a cross fade to fade out a reproduced output of the contents data and fade in a reproduced output of the informing sound so as to output a superposed output of the contents data and the informing sound, and an instructing unit that detects the occurrence of the event from the external equipment and instructs to execute the cross fade that fades out the reproduced output of the contents data and fades in the reproduced output of the informing sound.

According to the above configuration, the cross fade process can be executed independently of reproduction control of the contents data and the informing sound by carrying out this cross fade process at the same time the reproduced output of the contents data and the reproduced output of the informing sound of external event occurrence are superposed. Therefore, a processing load caused due to the cross fade process can be suppressed. Also, not the contents reproducing unit and the informing sound reproducing unit but the reproduced output of the contents and the reproduced output of the informing sound are selected as the control object of the cross fade process. Therefore, the cross fade process can be implemented simply not to exchange the existing contents reproducing unit and the existing sound reproducing unit.

Also, in the present invention, the superposing unit executes the cross fade that fades in the reproduced output of the contents data and fades out the reproduced output of the informing sound so as to output the superposed output of the contents data and the informing sound. The instructing unit detects an end of the event from the external equipment and instructs to execute a cross fade that fades in the reproduced output of the contents data and fades out the reproduced output of the informing sound.

According to the above configuration, not only a load of the cross fade process applied when the event occurs but also a load of the cross fade process applied when the event ends can be reduced.

### ADVANTAGES OF THE INVENTION

According to the present invention, the cross fade process can be executed independently of reproduction control of the contents data and the informing sound by carrying out this cross fade process at the same time the reproduced output of the contents data and the reproduced output of the informing sound of external event occurrence are superposed. Therefore, a processing load caused due to the cross fade process can be suppressed. Also, not the contents reproducing unit and the informing sound reproducing unit but the reproduced output of the contents and the reproduced output of the informing sound are selected as the control object of the cross fade process. Therefore, the cross fade process can be implemented simply not to exchange the existing contents reproducing unit and the existing sound reproducing unit.

### BRIEF DESCRIPTION OF THE DRAWINGS

FIG. 1 A view showing an internal configuration of an embodiment of the present invention.

FIG. 2 A flowchart showing procedures in a cross fade process in a mixer portion at a time of phone call incoming in the embodiment of the present invention.

FIG. 3 A view showing timing setting of the cross fade process in the mixer portion.

### DESCRIPTION OF REFERENCE NUMERALS

10 communicating portion
20 incoming call detecting portion
30 controlling portion
40 contents reproducing portion
50 ringtone reproducing portion
60 mixer portion
70 speaker
80 displaying portion

### BEST MODE FOR CARRYING OUT THE INVENTION

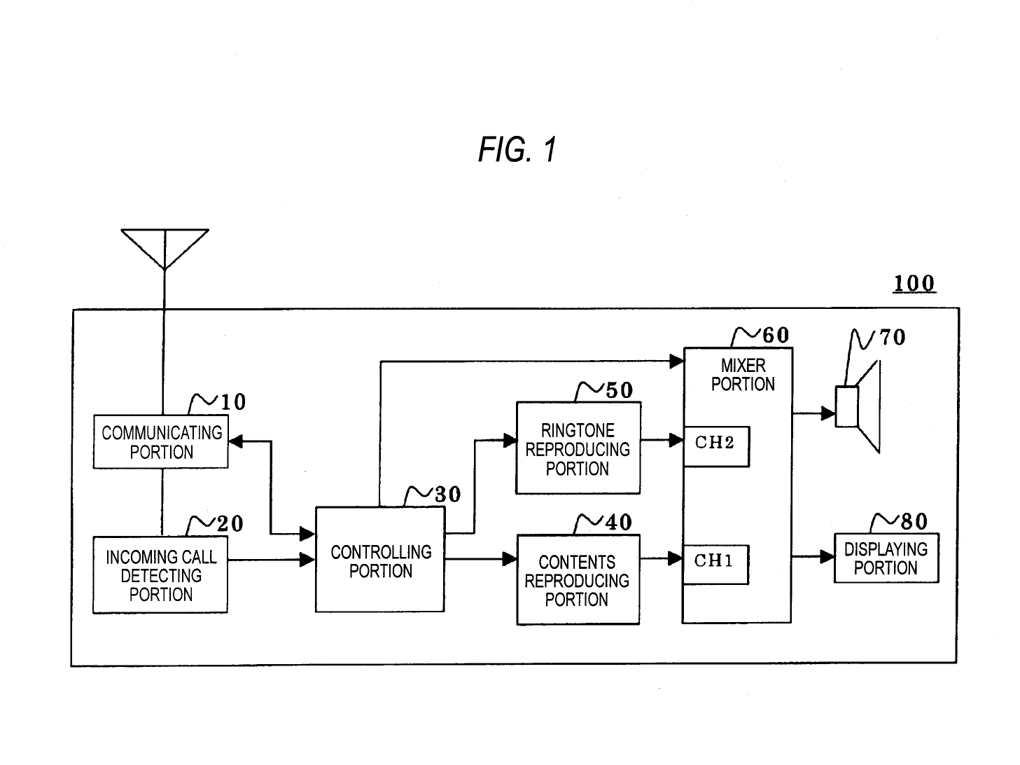

FIG. 1 is a view showing an internal configuration of a cellular phone terminal in an embodiment of the present invention. A cellular phone terminal 100 includes a communicating portion 10, an incoming call detecting portion 20, a controlling portion 30, a contents reproducing portion 40, a ringtone reproducing portion 50, a mixer portion 60, a speaker 70, and a displaying portion 80.

The communicating portion 10 is a wireless communication unit that controls an outgoing call and incoming call of a phone in the cellular phone terminal and transmits/receives a phone conversation, an electronic mail, or the like by holding a communication with a wireless base station constituting a public wireless telephone network. Here, since the publicly-known approach may be employed as the wireless communication, explanation of a detailed internal configuration of the communicating portion 10 and respective functions accomplished by such configuration will be omitted herein. The incoming call detecting portion 20 detects the phone call in the communicating portion 10, and informs the controlling portion 30 described later of this phone call. In this case, the incoming call detecting portion 20 detects the phone call as an event. As other events, there are a TV telephone call, a mail call, and an instant message call. Also, the incoming call detecting portion 20 detects a schedule alarm and a remaining battery life as an event in an alarm operation. Also, the incoming call detecting portion 20 detects an inside/outside cellphone service as an event.

The controlling portion 30 is constructed by CPU, ROM, RAM, etc., and supervises/controls the overall operation of the cellular phone terminal. Also, the controlling portion 30 instructs the mixer portion 60 described later to start the cross fade process of plural pieces of reproduced data such as input sound, image, and the like.

The contents reproducing portion 40 is a block that reproduces still picture, moving picture, sound, television broadcast received data, etc., and contains a decoder, a television tuner, and the like for reproducing image data and sound data. Also, in the present embodiment, the contents reproducing portion 40 contains a memory for storing contents data, an interface unit for acquiring the contents data from an external recording medium, etc. The ringtone reproducing portion 50 reproduces the ringtone (phone melody) to inform of the phone call. Also, the ringtone reproducing portion 50 can reproduce not only the sound but also the moving picture (incoming moving picture) related to the ringtone, and reproduces both the sound data and the image data. Data such as the phone melody, the incoming moving picture, etc. to be reproduced are stored previously in a memory of the ringtone reproducing portion 50 by various methods, for example, are downloaded previously via the communicating portion 10.

The mixer portion 60 receives reproduced data output from the contents reproducing portion 40 and the ringtone reproducing portion 50, and executes the cross fade process together with the superposition of both outputs. In the present embodiment, the mixer portion 60 receives the input via two systems consisting of a channel CH1 and a channel CH2. Here, the output of the contents reproducing portion 40 is applied to the channel CH1 and the output of the ringtone reproducing portion 50 is applied to the channel CH2. The mixer portion 60 carried out the cross fade process with respect to the inputs of the channel CH1 and the channel CH2 in compliance with a predetermined timing.

Here, levels of the sound and video outputs from the contents reproducing portion 40 and the ringtone reproducing portion 50 are always kept constant. For example, a balance between a volume of the reproduced contents and a volume of the ringtone and a change in balance are controlled by the mixer portion 60. Therefore, there is no need for the controlling portion 30 to control the output level sequentially and thus a processing load of the controlling portion 30 can be suppressed.

The speaker 70 reproduces the sound output superposed by the mixer portion 60 as the sound. Also, the displaying portion 80 is configured by the CRT, the liquid crystal display, the organic light-emitting display, or the like, and displays the video output superposed by the mixer portion 60 as the image.

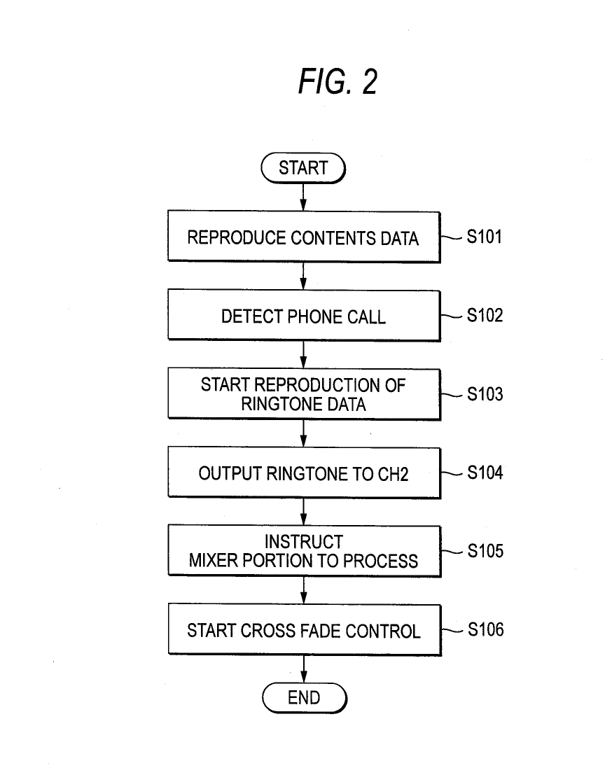

FIG. 2 is a flowchart showing procedures in the cross fade process in the mixer portion at a time of the phone call of the cellular phone terminal in the embodiment of the present invention. At first, when the incoming call detecting portion 20 detects the phone call (step S102) while the contents reproducing portion 40 is reproducing the contents data (step S101), the controlling portion 30 instructs the ringtone reproducing portion 50 to reproduce the previously stored data such as the ringtone, the incoming moving picture, and the like (step S103).

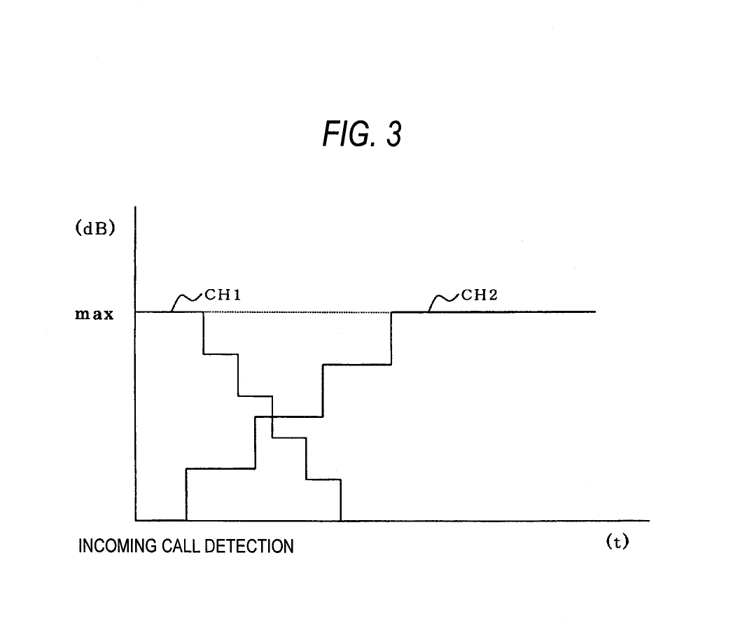

In the normal reproduction of contents data, the output of the contents reproducing portion 40 is input into the channel CH1 of the mixer portion 60, and then the sound is reproduced as it is by the speaker 70 and also the video is reproduced as it is by the displaying portion 80. When the incoming call detecting portion 20 detects the phone call, the output of the ringtone reproducing portion 50 is input into the channel CH2 of the mixer portion 60 (step S104). The controlling portion 30 instructs the mixer portion 60 to start the cross fade process (step S105). The mixer portion 60, when receives the processing instruction, executes the cross fade process by adjusting the output levels of two channels in time series in compliance with a predetermined timing shown in FIG. 3 (step S106). Also, when the incoming call detecting portion 20 detects end of the speaking/communication, the mixer portion 60 fades out the output of the ringtone reproducing portion 50 and also fades in the output of the contents reproducing portion 40, based on the cross fade process instruction issued from the controlling portion 30.

In this case, in the above embodiment, the timing setting pattern shown in FIG. 3 may be set or changed arbitrarily by the user of the cellular phone terminal. The mixer portion 60 executes the cross fade process in accordance with the set timing. Therefore, even when the timing setting pattern of the cross fade process is changed, no change takes place in the control sequence in the controlling portion 30 and therefore there is no necessity to change the control program, and the like.

Also, in the above embodiment, the number of input channels in the mixer portion 60 is set to 2. But the number of input channels is not limited to this number. The information terminal may be constructed in such a manner that two different contents or more are input separate channels, then superposed by the mixer portion 60, and then output, for example, the reproduced sound of music contents is input into CH1 and the reproduced sound of the television broadcast is input into CH3, or the like, and then the output of the ringtone reproducing portion 50 is input into CH2 to fade in and also the inputs except the ringtone are faded out when the incoming call is detected. At that time, the similar advantages can be achieved.

Also, the information terminal of the present invention is not limited to the cellular phone terminal. The information terminal such as PDA, game machine, or the like having a communicating function, the AV terminal such as portable audio, video camera, video monitor, video deck, DVD recorder, television set, radio set, digital television set, STB, or the like having a communicating function, and the communication terminal such as stationary telephone set, communication equipment, or the like having a contents reproducing function may be employed.

The present invention is explained in detail with reference to the particular embodiment. But it is obvious for the person skilled in the art that various variations and modifications can be applied without departing from a spirit and a scope of the present invention.

This application is based upon Japanese Patent Application (Patent Application No. 2004-247928) filed on Aug. 27, 2004, the contents of which are incorporated herein by reference.

### INDUSTRIAL APPLICABILITY

The information terminal of the present invention can possess such advantages that, since the cross fade process can be executed at the same time the reproduced output of the contents data and the reproduced output of the ringtone are superposed, such cross fade process can be executed independently of reproduction control of the contents data and the ringtone and thus a processing load of the cross fade process can be suppressed and that, since not the contents reproducing portion and the ringtone reproducing portion but the reproduced output of the contents and the reproduced output of the ringtone are selected as the control object of the cross fade process, the cross fade process can be implemented simply not to exchange the existing contents reproducing portion and the existing ringtone reproducing portion. As a result, the information terminal of the present invention is useful for the technology that controls the contents reproducing operation when the phone call incomes into the information terminal during reproduction of the contents, and others.

1. An information terminal having a contents reproducing function, comprising:
a contents reproducing unit that reproduces contents data;
an informing sound reproducing unit that reproduces an informing sound of occurrence of an event by detecting the event from an external equipment;
a superposing unit that executes a cross fade to fade out a reproduced output of the contents data and fade in a reproduced output of the informing sound so as to output a superposed output of the contents data and the informing sound; and
an instructing unit that detects the occurrence of the event from the external equipment and instructs to execute the cross fade that fades out the reproduced output of the contents data and fades in the reproduced output of the informing sound.

2. The information terminal according to claim 1, wherein the superposing unit executes the cross fade that fades in the reproduced output of the contents data and fades out the reproduced output of the informing sound so as to output the superposed output of the contents data and the informing sound; and
wherein the instructing unit detects an end of the event from the external equipment and instructs to execute a cross fade that fades in the reproduced output of the contents data and fades out the reproduced output of the informing sound.
